(19) United States
(12) Patent Application Publication
(10) Pub. No.: US 2018/0124067 A1
(43) Pub. Date: May 3, 2018

(54) DATA ACCESS MANAGEMENT

(71) Applicant: International Business Machines Corporation, Armonk, NY (US)

(72) Inventors: Jimson K. John, Bangalore (IN); Tejaswini Papanna, Mysore (IN); Gaurav Saxena, Bangalore (IN); Mangesh V. Shanbhag, Bangalore (IN)

(21) Appl. No.: 15/337,403

(22) Filed: Oct. 28, 2016

(51) Int. Cl. H04L 29/06; G06F 17/30; G06Q 30/02; G06Q 50/00; G06F 3/0482; G06F 3/0484

(52) U.S. Cl. CPC H04L 63/108; G06F 17/30864; G06F 3/04847; G06Q 50/01; G06F 3/0482; G06Q 30/0277

(57) ABSTRACT

A set of user-configurable access control toggles is provided to a non-administrator user. The set of user-configurable access control toggles indicates access authorization to a set of data for a set of assets. A prevention selection with respect to a first subset of the set of user-configurable access control toggles is received from the non-administrator user. The prevention selection indicates to prevent access to a first subset of the set of data for a first subset of the set of assets. A first access request to the first subset of the set of data is received from the first subset of the set of assets. Based on the prevention selection with respect to the first subset of the set of user-configurable access control toggles, performance of the first access request to the first subset of the set of data by the first subset of the set of assets is prevented.

### BACKGROUND

This disclosure relates generally to computer systems and, more particularly, relates to data access management. Databases are used to store information for numerous types of applications. Examples include various industrial, commercial, technical, scientific, and educational applications. Database management systems (DBMSs) are a typical mechanism for accessing data stored in a database. DBMSs are typically configured to separate the process of storing data from accessing, manipulating, or using data stored in a database. DBMSs often require tremendous resources to handle the heavy workloads placed on such systems. As such, it may be useful to increase the performance of database management systems with respect to processing searches, or queries, to databases.

### SUMMARY

Aspects of the disclosure relate to providing management control to a non-administrator user with respect to an ability to toggle access control. Instead of a database administrator fixing controls, the non-administrator user may toggle between read-type, write-type, or prevention of access to individual rows and columns with necessary privilege granted by the database administrator to do so. According to aspects described herein, an administrator-user can define an ability to toggle access control by one or more non-administrator users. Accordingly, when enabled, a non-administrator user then can make one or more selections to enable or disable access to information on a granular basis. Aspects may apply to databases, application programs, virtualization, cloud computing, or other computing objects that may benefits from dynamic, as opposed to static, toggling of access control. As such, non-administrator users may have more granular control on what should be shown for their profile, may save the non-administrator user from embarrassment by not displaying unwanted information at certain times or places, and may provide an option to view otherwise hidden content or perform analytical tasks at suitable times.

Disclosed aspects relate to data access management. A set of user-configurable access control toggles is provided to a non-administrator user. The set of user-configurable access control toggles indicates access authorization to a set of data for a set of assets. A prevention selection with respect to a first subset of the set of user-configurable access control toggles is received from the non-administrator user. The prevention selection indicates to prevent access to a first subset of the set of data for a first subset of the set of assets. A first access request to the first subset of the set of data is received from the first subset of the set of assets. Based on the prevention selection with respect to the first subset of the set of user-configurable access control toggles, performance of the first access request to the first subset of the set of data by the first subset of the set of assets is prevented.

The above summary is not intended to describe each illustrated embodiment or every implementation of the present disclosure.

### BRIEF DESCRIPTION OF THE SEVERAL VIEWS OF THE DRAWINGS

The drawings included in the present application are incorporated into, and form part of, the specification. They illustrate embodiments of the present disclosure and, along with the description, serve to explain the principles of the disclosure. The drawings are only illustrative of certain embodiments and do not limit the disclosure.

FIG. 1 depicts a cloud computing node according to embodiments.

FIG. 2 depicts a cloud computing environment according to embodiments.

FIG. 3 depicts abstraction model layers according to embodiments.

FIG. 4 illustrates an example representation of a computer system connected to a client computer via a network according to embodiments.

FIG. 5 illustrates an example database management system (DBMS) according to embodiments.

FIG. 6 shows an example system for data access management according to embodiments.

While the invention is amenable to various modifications and alternative forms, specifics thereof have been shown by way of example in the drawings and will be described in detail. It should be understood, however, that the intention is not to limit the invention to the particular embodiments described. On the contrary, the intention is to cover all modifications, equivalents, and alternatives falling within the spirit and scope of the invention.

### DETAILED DESCRIPTION

Aspects of the disclosure relate to providing management control to a non-administrator user with respect to an ability to toggle access control. Instead of a database administrator fixing controls, the non-administrator user may toggle between read-type, write-type, or prevention of access to individual rows and columns with necessary privilege granted by the database administrator to do so. According to aspects described herein, an administrator-user can define an ability to toggle access control by one or more non-administrator users. Accordingly, when enabled, a non-administrator user then can make one or more selections to enable or disable access to information on a granular basis. Aspects may apply to databases, application programs, virtualization, cloud computing, or other computing objects that may benefits from dynamic, as opposed to static, toggling of access control. As such, non-administrator users may have more granular control on what should be shown for their profile, may save the non-administrator user from embarrassment by not displaying unwanted information at certain times or places, and may provide an option to view otherwise hidden content or perform analytical tasks at suitable times.

Managing access to delicate information may pose challenges. If many applications are sharing and using delicate information and transaction history, providing access controls to such delicate information that may be managed/controlled by a non-administrator user who the information is about may be beneficial (e.g., certain non-administrator users may prefer to have their information handled differently than other non-administrator users). For instance, when a non-administrator user visits a retail website, a transaction history of the client may be stored with respect to their customer profile. Based on the transaction history, individualized advertisements may be displayed to the non-administrator user when visiting the retail website or similar retail website. As such, the non-administrator user may not want certain advertisements to be displayed at all times. Accordingly, in such an example embodiment, the non-administrator user may be provided enhanced controls on what advertisements to be shown, and when such advertisements may be shown.

Aspects of the disclosure include a computer-implemented method, system, and computer program product for data access management. A set of user-configurable access control toggles is provided to a non-administrator user. The set of user-configurable access control toggles indicates access authorization to a set of data for a set of assets. A prevention selection with respect to a first subset of the set of user-configurable access control toggles is received from the non-administrator user. The prevention selection indicates to prevent access to a first subset of the set of data for a first subset of the set of assets. A first access request to the first subset of the set of data is received from the first subset of the set of assets. Based on the prevention selection with respect to the first subset of the set of user-configurable access control toggles, performance of the first access request to the first subset of the set of data by the first subset of the set of assets is prevented.

In embodiments, a second access request to a second subset of the set of data by the first subset of the set of assets may be allowed (e.g., allow the same asset to access different data). In various embodiments, a second access request to the first subset of the set of data by a second subset of the set of assets may be allowed (e.g., allow the same data to be accessed by a different asset). In embodiments, the set of data includes a set of records of a database. In various embodiments, the set of assets includes a set of application programs. Altogether, performance or efficiency benefits related to data access management may occur (e.g., speed, flexibility, security, load balancing, responsiveness, high availability, resource usage, productivity). Aspects may save computing resources such as bandwidth, processing, or memory.

It is understood in advance that although this disclosure includes a detailed description on cloud computing, implementation of the teachings recited herein are not limited to a cloud computing environment. Rather, embodiments of the present invention are capable of being implemented in conjunction with any other type of computing environment now known or later developed.

Cloud computing is a model of service delivery for enabling convenient, on-demand network access to a shared pool of configurable computing resources (e.g., networks, network bandwidth, servers, processing, memory, storage, applications, virtual machines, and services) that can be rapidly provisioned and released with minimal management effort or interaction with a provider of the service. This cloud model may include at least five characteristics, at least three service models, and at least four deployment models.

Characteristics are as follows:

On-demand self-service: a cloud consumer can unilaterally provision computing capabilities, such as server time and network storage, as needed automatically without requiring human interaction with the service's provider.

Broad network access: capabilities are available over a network and accessed through standard mechanisms that promote use by heterogeneous thin or thick client platforms (e.g., mobile phones, laptops, and PDAs).

Resource pooling: the provider's computing resources are pooled to serve multiple consumers using a multi-tenant model, with different physical and virtual resources dynamically assigned and reassigned according to demand. There is a sense of location independence in that the consumer generally has no control or knowledge over the exact location of the provided resources but may be able to specify location at a higher level of abstraction (e.g., country, state, or datacenter).

Rapid elasticity: capabilities can be rapidly and elastically provisioned, in some cases automatically, to quickly scale out and rapidly released to quickly scale in. To the consumer, the capabilities available for provisioning often appear to be unlimited and can be purchased in any quantity at any time.

Measured service: cloud systems automatically control and optimize resource use by leveraging a metering capability at some level of abstraction appropriate to the type of service (e.g., storage, processing, bandwidth, and active user accounts). Resource usage can be monitored, controlled, and reported providing transparency for both the provider and consumer of the utilized service.

Service Models are as follows:

Software as a Service (SaaS): the capability provided to the consumer is to use the provider's applications running on a cloud infrastructure. The applications are accessible from various client devices through a thin client interface such as a web browser (e.g., web-based e-mail). The consumer does not manage or control the underlying cloud infrastructure including network, servers, operating systems, storage, or even individual application capabilities, with the possible exception of limited user-specific application configuration settings.

Platform as a Service (PaaS): the capability provided to the consumer is to deploy onto the cloud infrastructure consumer-created or acquired applications created using programming languages and tools supported by the provider. The consumer does not manage or control the underlying cloud infrastructure including networks, servers, operating systems, or storage, but has control over the deployed applications and possibly application hosting environment configurations.

Infrastructure as a Service (IaaS): the capability provided to the consumer is to provision processing, storage, networks, and other fundamental computing resources where the consumer is able to deploy and run arbitrary software, which can include operating systems and applications. The consumer does not manage or control the underlying cloud infrastructure but has control over operating systems, storage, deployed applications, and possibly limited control of select networking components (e.g., host firewalls).

Deployment Models are as follows:

Private cloud: the cloud infrastructure is operated solely for an organization. It may be managed by the organization or a third party and may exist on-premises or off-premises.

Community cloud: the cloud infrastructure is shared by several organizations and supports a specific community that has shared concerns (e.g., mission, security requirements, policy, and compliance considerations). It may be managed by the organizations or a third party and may exist on-premises or off-premises.

Public cloud: the cloud infrastructure is made available to the general public or a large industry group and is owned by an organization selling cloud services.

Hybrid cloud: the cloud infrastructure is a composition of two or more clouds (private, community, or public) that remain unique entities but are bound together by standardized or proprietary technology that enables data and application portability (e.g., cloud bursting for load-balancing between clouds).

A cloud computing environment is service oriented with a focus on statelessness, low coupling, modularity, and semantic interoperability. At the heart of cloud computing is an infrastructure comprising a network of interconnected nodes.

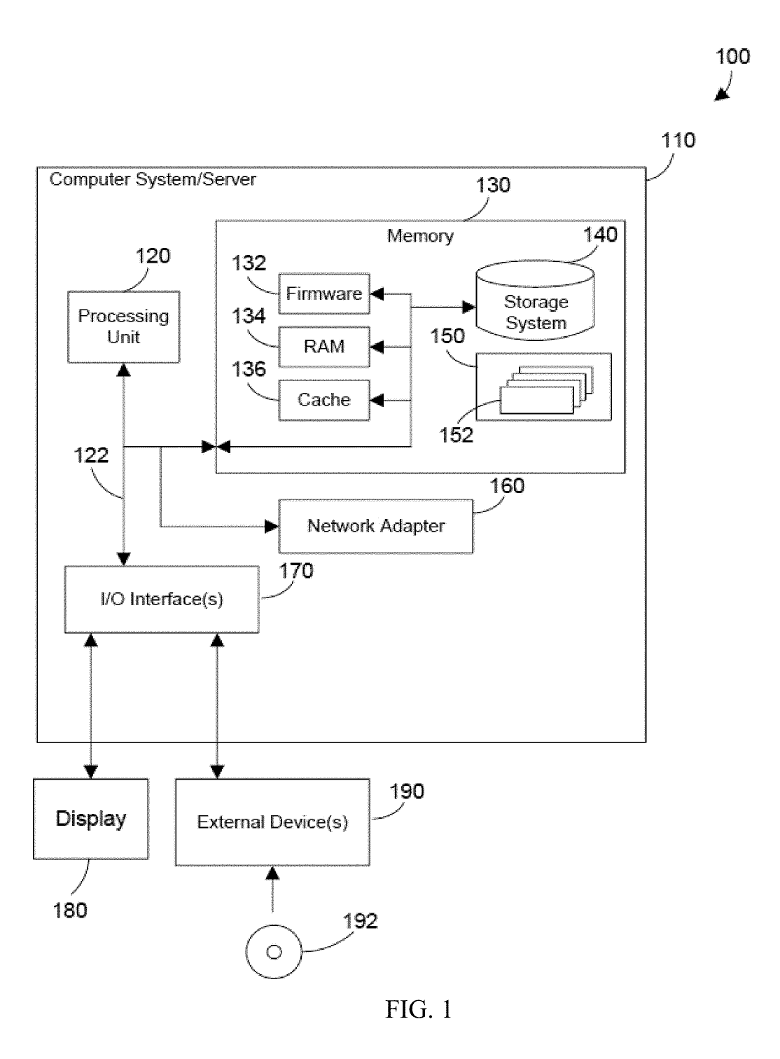

Referring now to FIG. 1, a block diagram of an example of a cloud computing node is shown. Cloud computing node 100 is only one example of a suitable cloud computing node and is not intended to suggest any limitation as to the scope of use or functionality of embodiments of the invention described herein. Regardless, cloud computing node 100 is capable of being implemented and/or performing any of the functionality set forth hereinabove.

In cloud computing node 100 there is a computer system/server 110, which is operational with numerous other general purpose or special purpose computing system environments or configurations. Examples of well-known computing systems, environments, and/or configurations that may be suitable for use with computer system/server 110 include, but are not limited to, personal computer systems, server computer systems, tablet computer systems, thin clients, thick clients, handheld or laptop devices, multiprocessor systems, microprocessor-based systems, set top boxes, programmable consumer electronics, network PCs, minicomputer systems, mainframe computer systems, and distributed cloud computing environments that include any of the above systems or devices, and the like.

Computer system/server 110 may be described in the general context of computer system executable instructions, such as program modules, being executed by a computer system. Generally, program modules may include routines, programs, objects, components, logic, data structures, and so on that perform particular tasks or implement particular abstract data types. Computer system/server 110 may be practiced in distributed cloud computing environments where tasks are performed by remote processing devices that are linked through a communications network. In a distributed cloud computing environment, program modules may be located in both local and remote computer system storage media including memory storage devices.

As shown in FIG. 1, computer system/server 110 in cloud computing node 100 is shown in the form of a general-purpose computing device. The components of computer system/server 110 may include, but are not limited to, one or more processors or processing units 120, a system memory 130, and a bus 122 that couples various system components including system memory 130 to processing unit 120.

Bus 122 represents one or more of any of several types of bus structures, including a memory bus or memory controller, a peripheral bus, an accelerated graphics port, and a processor or local bus using any of a variety of bus architectures. By way of example, and not limitation, such architectures include Industry Standard Architecture (ISA) bus, Micro Channel Architecture (MCA) bus, Enhanced ISA (EISA) bus, Video Electronics Standards Association (VESA) local bus, and Peripheral Component Interconnect (PCI) bus.

Computer system/server 110 typically includes a variety of computer system readable media. Such media may be any available media that is accessible by computer system/server 110, and it includes both volatile and non-volatile media, removable and non-removable media. An example of removable media is shown in FIG. 1 to include a Digital Video Disc (DVD) 192.

System memory 130 can include computer system readable media in the form of volatile or non-volatile memory, such as firmware 132. Firmware 132 provides an interface to the hardware of computer system/server 110. System memory 130 can also include computer system readable media in the form of volatile memory, such as random access memory (RAM) 134 and/or cache memory 136. Computer system/server 110 may further include other removable/non-removable, volatile/non-volatile computer system storage media. By way of example only, storage system 140 can be provided for reading from and writing to a non-removable, non-volatile magnetic media (not shown and typically called a “hard drive”). Although not shown, a magnetic disk drive for reading from and writing to a removable, non-volatile magnetic disk (e.g., a “floppy disk”), and an optical disk drive for reading from or writing to a removable, non-volatile optical disk such as a CD-ROM, DVD-ROM or other optical media can be provided. In such instances, each can be connected to bus 122 by one or more data media interfaces. As will be further depicted and described below, memory 130 may include at least one program product having a set (e.g., at least one) of program modules that are configured to carry out the functions described in more detail below.

Program/utility 150, having a set (at least one) of program modules 152, may be stored in memory 130 by way of example, and not limitation, as well as an operating system, one or more application programs, other program modules, and program data. Each of the operating system, one or more application programs, other program modules, and program data or some combination thereof, may include an implementation of a networking environment. Program modules 152 generally carry out the functions and/or methodologies of embodiments of the invention as described herein.

Computer system/server 110 may also communicate with one or more external devices 190 such as a keyboard, a pointing device, a display 180, a disk drive, etc.; one or more devices that enable a user to interact with computer system/server 110; and/or any devices (e.g., network card, modem, etc.) that enable computer system/server 110 to communicate with one or more other computing devices. Such communication can occur via Input/Output (I/O) interfaces 170. Still yet, computer system/server 110 can communicate with one or more networks such as a local area network (LAN), a general wide area network (WAN), and/or a public network (e.g., the Internet) via network adapter 160. As depicted, network adapter 160 communicates with the other components of computer system/server 110 via bus 122. It should be understood that although not shown, other hardware and/or software components could be used in conjunction with computer system/server 110. Examples, include, but are not limited to: microcode, device drivers, redundant processing units, external disk drive arrays, Redundant Array of Independent Disk (RAID) systems, tape drives, data archival storage systems, etc.

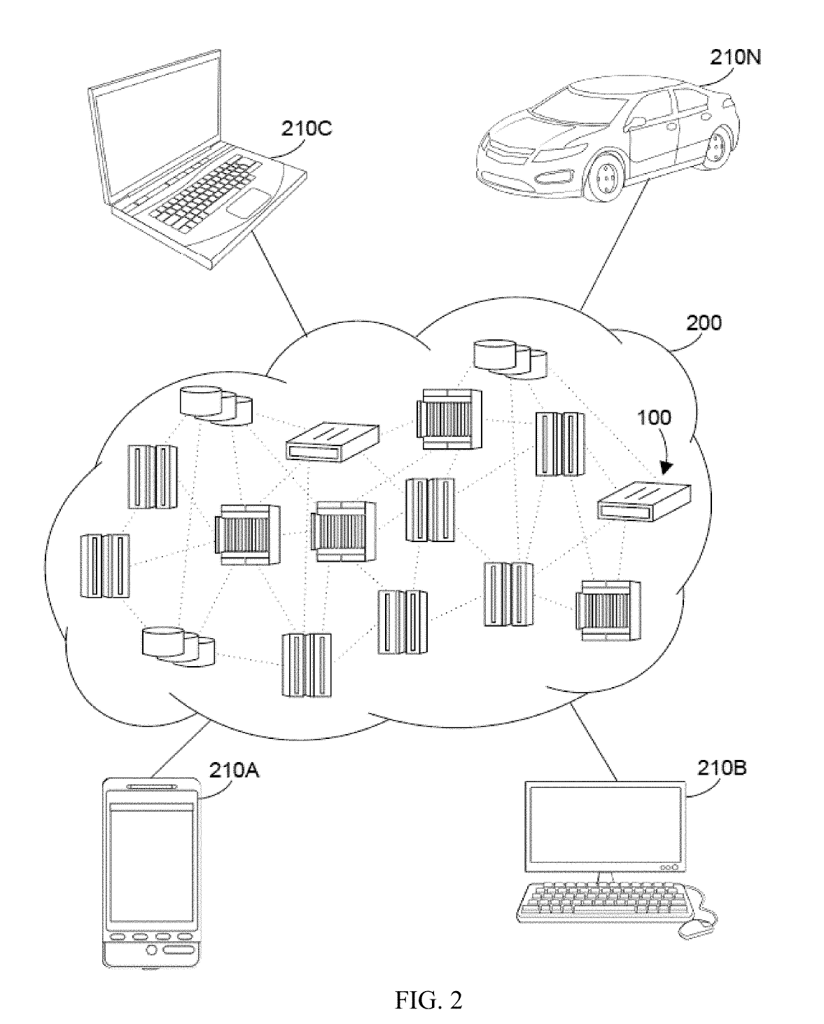

Referring now to FIG. 2, illustrative cloud computing environment 200 is depicted. As shown, cloud computing environment 200 comprises one or more cloud computing nodes 100 with which local computing devices used by cloud consumers, such as, for example, personal digital assistant (PDA) or cellular telephone 210A, desktop computer 210B, laptop computer 210C, and/or automobile computer system 210N may communicate. Nodes 100 may communicate with one another. They may be grouped (not shown) physically or virtually, in one or more networks, such as Private, Community, Public, or Hybrid clouds as described hereinabove, or a combination thereof. This allows cloud computing environment 200 to offer infrastructure, platforms and/or software as services for which a cloud consumer does not need to maintain resources on a local computing device. It is understood that the types of computing devices 210A-N shown in FIG. 2 are intended to be illustrative only and that computing nodes 100 and cloud computing environment 200 can communicate with any type of computerized device over any type of network and/or network addressable connection (e.g., using a web browser).

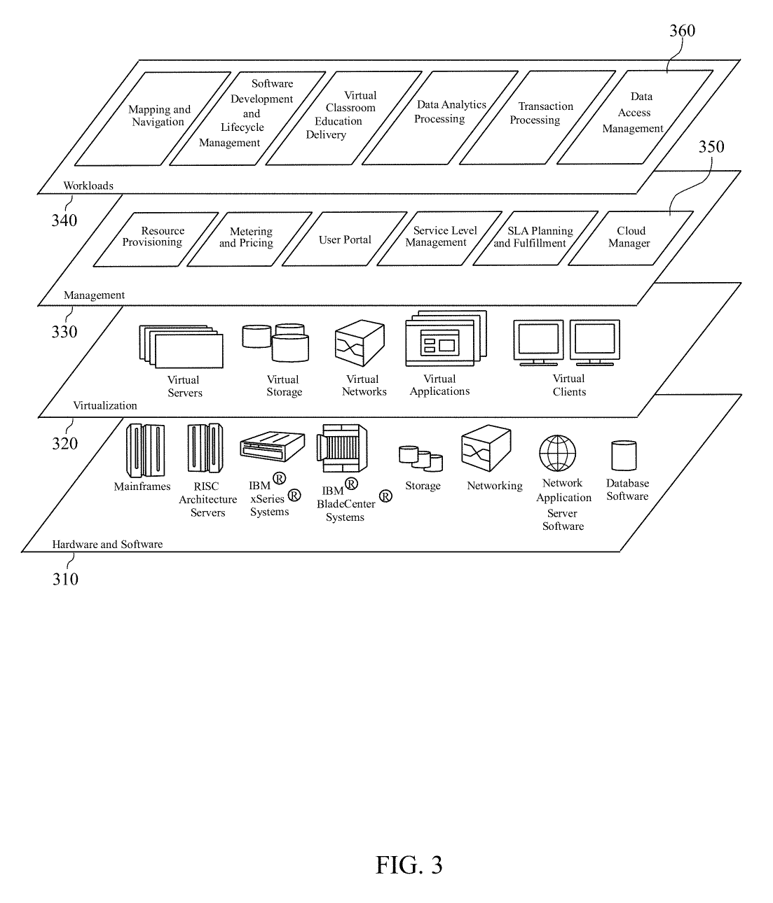

Referring now to FIG. 3, a set of functional abstraction layers provided by cloud computing environment 200 in FIG. 2 is shown. It should be understood in advance that the components, layers, and functions shown in FIG. 3 are intended to be illustrative only and the disclosure and claims are not limited thereto. As depicted, the following layers and corresponding functions are provided.

Hardware and software layer 310 includes hardware and software components. Examples of hardware components include mainframes, in one example IBM System z systems; RISC (Reduced Instruction Set Computer) architecture based servers, in one example IBM System p systems; IBM System x systems; IBM BladeCenter systems; storage devices; networks and networking components. Examples of software components include network application server software, in one example IBM Web Sphere® application server software; and database software, in one example IBM DB2® database software. IBM, System z, System p, System x, BladeCenter, WebSphere, and DB2 are trademarks of International Business Machines Corporation registered in many jurisdictions worldwide.

Virtualization layer 320 provides an abstraction layer from which the following examples of virtual entities may be provided: virtual servers; virtual storage; virtual networks, including virtual private networks; virtual applications and operating systems; and virtual clients.

In one example, management layer 330 may provide the functions described below. Resource provisioning provides dynamic procurement of computing resources and other resources that are utilized to perform tasks within the cloud computing environment. Metering and Pricing provide cost tracking as resources are utilized within the cloud computing environment, and billing or invoicing for consumption of these resources. In one example, these resources may comprise application software licenses. Security provides identity verification for cloud consumers and tasks, as well as protection for data and other resources. User portal provides access to the cloud computing environment for consumers and system administrators. Service level management provides cloud computing resource allocation and management such that required service levels are met. Service Level Agreement (SLA) planning and fulfillment provide pre-arrangement for, and procurement of, cloud computing resources for which a future requirement is anticipated in accordance with an SLA. A cloud manager 350 is representative of a cloud manager (or shared pool manager) as described in more detail below. While the cloud manager 350 is shown in FIG. 3 to reside in the management layer 330, cloud manager 350 can span all of the levels shown in FIG. 3, as discussed below.

Workloads layer 340 provides examples of functionality for which the cloud computing environment may be utilized. Examples of workloads and functions which may be provided from this layer include: mapping and navigation; software development and lifecycle management; virtual classroom education delivery; data analytics processing; transaction processing; and a data access management layer 360, which relates to using a database driver as discussed in more detail herein.

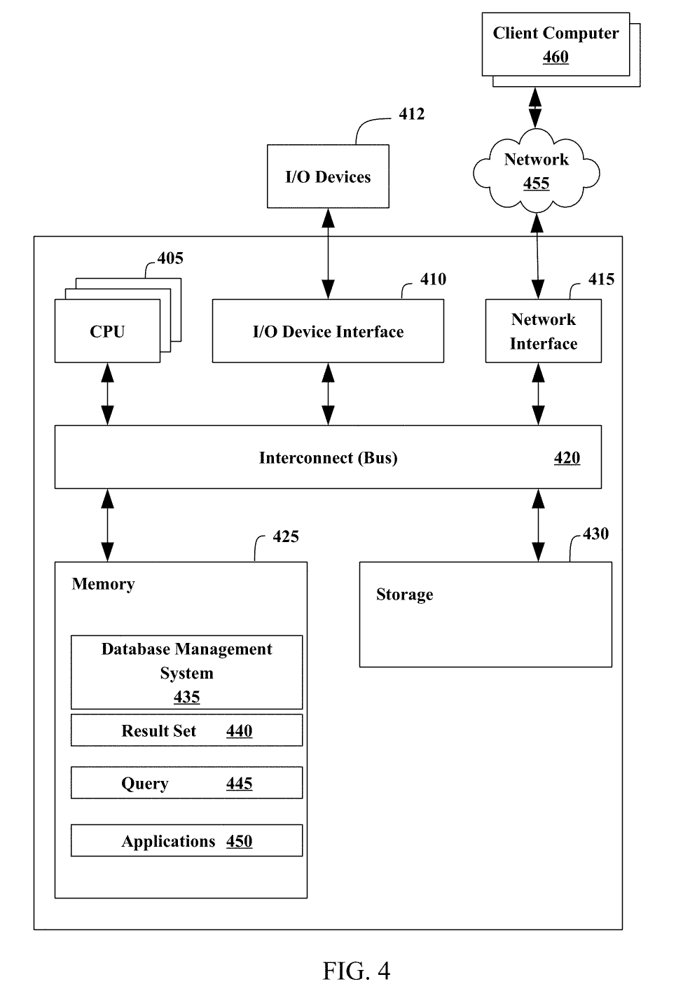

FIG. 4 illustrates an example representation of a computer system 400 connected to one or more client computers 460 via a network 455, according to some embodiments. For the purposes of this disclosure, computer system 400 may represent practically any type of computer, computer system, or other programmable electronic device, including but not limited to, a client computer, a server computer, a portable computer, a handheld computer, an embedded controller, etc. In some embodiments, computer system 400 may be implemented using one or more networked computers, e.g., in a cluster or other distributed computing system.

The computer system 400 may include, without limitation, one or more processors (CPUs) 105, a network interface 415, an interconnect 420, a memory 425, and a storage 430. The computer system 400 may also include an I/O device interface 410 used to connect I/O devices 412, e.g., keyboard, display, and mouse devices, to the computer system 400.

Each processor 405 may retrieve and execute programming instructions stored in the memory 425 or storage 430. Similarly, the processor 405 may store and retrieve application data residing in the memory 425. The interconnect 420 may transmit programming instructions and application data between each processor 405, I/O device interface 410, network interface 415, memory 425, and storage 430. The interconnect 420 may be one or more busses. The processor 405 may be a single central processing unit (CPU), multiple CPUs, or a single CPU having multiple processing cores in various embodiments. In one embodiment, a processor 405 may be a digital signal processor (DSP).

The memory 425 may be representative of a random access memory, e.g., Static Random Access Memory (SRAM), Dynamic Random Access Memory (DRAM), read-only memory, or flash memory. The storage 430 may be representative of a non-volatile memory, such as a hard disk drive, solid state device (SSD), or removable memory cards, optical storage, flash memory devices, network attached storage (NAS), or connections to storage area network (SAN) devices, or other devices that may store non-volatile data. The network interface 415 may be configured to transmit data via the communications network 455.

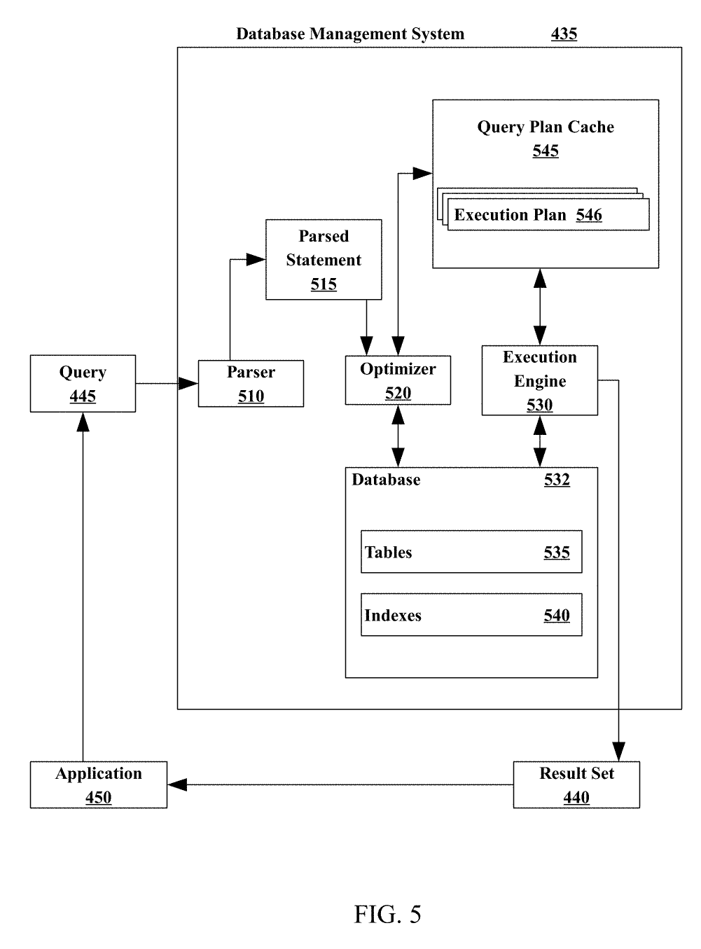

The memory 425 may include a database management system (DBMS) 435, a result set 440, a query 445, and applications 450. Although these elements are illustrated as residing in the memory 425, any of the elements, or combinations thereof, may reside in the storage 430 or partially in the memory 425 and partially in the storage 430. Each of these elements will be described in greater detail in accordance with FIG. 5.

The network 455 may be any suitable network or combination of networks and may support any appropriate protocol suitable for communication of data and/or code to/from the server computer system 400 and the client computer system 460. In some embodiments, the network 455 may support wireless communications. In other embodiments, the network 455 may support hardwired communications. The network 455 may be the Internet and may support Internet Protocol in some embodiments. In other embodiments, the network 455 may be implemented as a local area network (LAN) or a wide area network (WAN). The network 455 may also be implemented as a cellular data network. Although the network 455 is shown as a single network in the figures, one or more networks of the same or different types may be included.

The client computer system 460 may include some or all of the hardware and software elements of the computer system 400 previously described. As shown, there may be one or more client computers 460 connected to the computer system 400 via the network 455. In some embodiments, one or more client computers 460 may send a query 445 by network 455 to computer system 400 and receive a result set 440.

FIG. 5 illustrates an example database management system (DBMS) 435. The DBMS 435 may include a parser 510, an optimizer 520, an execution engine 530, and a database 532. The parser 510 may receive a database query 445 from an application 450. In some embodiments, the database query 445 may be in the form of a Structured Query Language (SQL) statement. The parser 510 may generate a parsed statement 515. The parser 510 may send the parsed statement 515 to an optimizer 520. The optimizer 520 may attempt to optimize the parsed statement. In some embodiments, optimizing may improve the performance of the database query 445 by, for example, reducing the amount of time it takes to provide a user with a response. The optimizer 520 may generate an execution plan 546 (may also be referred to as a query plan or an access plan), which may be maintained in a query plan cache 545, according to some embodiments. The query plan cache 545 may include one or more execution plans 546, including the current execution plan as well as previously used execution plans. Once an execution plan 546 is generated, the execution plan 546 may be sent to the execution engine 530. The execution engine 530 may execute the query 445. Executing the query 445 may include finding and retrieving data in the database tables 535 that satisfies the criteria supplied in the query 445. The execution engine 530 may store the data returned matching the query 445 in a result set 440. The DBMS 435 may return the result set 440 to an application 450, such as the application in which the database query 445 was generated, as a response to the database query 445.

A database 532 may include one or more tables 535 and, in some embodiments, one or more indexes 540. A database table 535 may organize data into rows and columns. Each row of a database table 535 may correspond to an individual entry, a tuple, or a record in the database 532. A column may define what is stored in each entry, tuple, or record. In some embodiments, columns of a table 535 may also be referred to as fields or attributes. Each table 535 within the database 532 may have a unique name. Each column within a table 535 may also have a unique name. A row, tuple, or record, however, within a particular table 535 may not be unique, according to some embodiments. A database 532 may also include one or more indexes 540. An index 540 may be a data structure that may inform the DBMS 435 of the location of a particular record within a table 535 if given a particular indexed column value. In some embodiments, the execution engine 530 may use the one or more indexes 540 to locate data within a table 535. In other embodiments, the execution engine 530 may scan the tables 535 without using an index 540.

As mentioned herein, the optimizer 520 creates the query access plan. The optimizer 520 may be implemented as computer program instructions that optimize the access plan in dependence upon database management statistics. Database statistics may reveal, for example, that there are only two identification values in a transactions table—so that it is an optimization, that is, more efficient, to scan the transactions table rather than using an index. Alternatively, database statistics may reveal that there are many transaction records with only a few transaction records for each identification value—so that it is an optimization, that is, more efficient, to access the transaction records by an index.

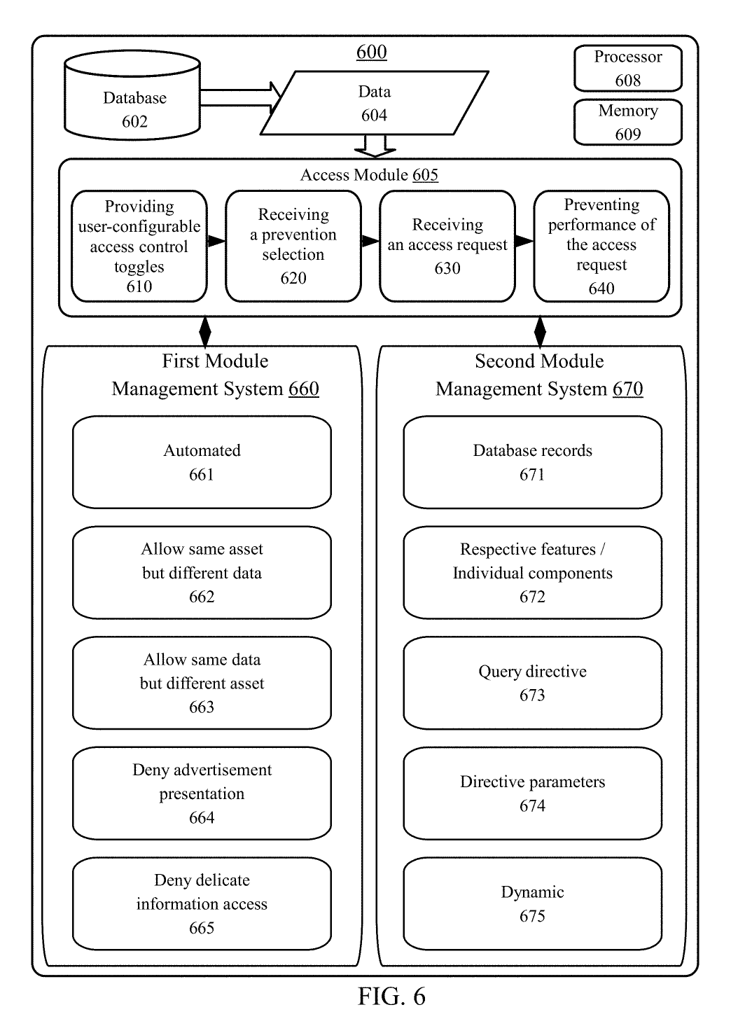

FIG. 6 shows an example system 600 for data access management according to embodiments. In certain embodiments, the example system 600 may illustrate one or more features of a database management system (DBMS). The example system 600 includes a (computer/hardware) processor 608 and a memory 609. The example system 600 has a database 602 and has data 604. The data 604 may be used for operation(s) with respect to aspects described herein (e.g., access module 605).

The example system 600 can include an access module 605. The access module 605 may include a providing module 610, a receiving module 620, a receiving module 630, and a preventing module 640. In embodiments, the example system 600 includes a first module management system 660. The first module management system 660 may have an automated module 661, a first allowance module 662, a second allowance module 663, a first denial module 664, and a second denial module 665. In embodiments, the example system 600 includes a second module management system 670. The second module management system 670 may have a database records module 671, a respective/individualized module 672, a query directive module 673, a directive parameters module 674, and a dynamic module 675. In certain embodiments, an administrator-user may select enablement of a set of user-configurable access control toggles in advance of providing the set of user-configurable access control toggles to the non-administrator user (e.g., to permit utilization of the capabilities provided herein which otherwise may not be available to the non-administrator user).

At the providing module 610, a set of user-configurable access control toggles is provided. The set of user-configurable access control toggles is provided to a non-administrator user. The set of user-configurable access control toggles which indicates access authorization to a set of data for a set of assets. The set of user-configurable access control toggles may be changeable (e.g., not static) such that a user may alter, modify, switch, or toggle a selection, setting, parameter, or configuration. Such toggling may occur dynamically during operation of an asset such as an application program (e.g., different from before start-up of the asset). Providing can include introducing, presenting, communicating, conveying, notifying, displaying (e.g., via a graphical user interface), or the like. The non-administrator user may be different from a database administrator, cloud manager, or the like. The non-administrator user can include a user/individual that operates an asset to process/transform data/information, create/generate an output/product, or utilize the asset without responsibility for managing or controlling its operations (e.g., the availability of the asset). The access authorization may relate to preventing access or allowing access (e.g., using various permissions or verifications) such as read access, write access, or the like. The set of assets can include one or more application programs, virtual machines, compute nodes, compute users, logical partitions, or the like. In certain embodiments, the set of assets is a specific application program being used in real-time by the non-administrator user. To illustrate, a plurality of radio buttons may be presented to the non-administrator user to select/toggle the set of user-configurable access control toggles to prevent/allow access to (one or more subsets of) the set of data.

At the receiving module 620, a prevention selection is received. The prevention selection is received from the non-administrator user. Receiving can include detecting, sensing, accepting as an input, or otherwise accepting delivery of the prevention selection (e.g., via a communicative connection with the non-administrator user). The prevention selection is with respect to a first subset of the set of user-configurable access control toggles (e.g., at least a portion of the toggles, all of the toggles, only toggles which correspond with delicate information) which indicates to prevent access to a first subset of the set of data (e.g., at least a portion of the data, all of the toggles, delicate information) for a first subset of the set of assets (e.g., a single asset, some assets, all assets). Accordingly, the prevention selection can include an indicator, an indication, or the like which may be acquired via a selecting operation by the non-administrator user. Selecting can include, for example, saving a data value (e.g., entering a digit/character in a data store), transmitting a data object (e.g., sending an object having metadata), routing a message (e.g., publishing a startup/wait expectation), or providing/performing/processing an operation (e.g., a notification). For example, the prevention selection can include storing a data value which may be configured to deny access to a portion of data.

At the receiving module 630, a first access request is received. The first access request is to the first subset of the set of data. The first access request is from the first subset of the set of assets. Receiving can include detecting, sensing, accepting as an input, or otherwise accepting delivery of the first access request. The first access request may include a message, packet, or transmission which seeks to read or write at least a portion of the set of data such as the first subset of the set of data (e.g., write to a portion of the set of data, read all of the set of data). Transmission of the first access request may occur by a first subset of the set of assets (e.g., a single asset, some assets, all assets). The first access request may include a query (e.g., find information that meets a criteria), open command (e.g., open a file such as a document), play command (e.g., play a video), display command (e.g., display a still image), edit command (e.g., change a data entry), or the like.

At the preventing module 640, performance of the first access request to the first subset of the set of data by the first subset of the set of assets is prevented. Such performance is prevented based on the prevention selection with respect to the first subset of the set of user-configurable access control toggles. Preventing can include rejecting, not allowing/receiving, disabling, disallowing, prohibiting, blocking, disregarding, suppressing, ignoring, precluding, at least deterring, or the like. For example, in response to the non-administrator user making the prevention selection for a chosen portion of an asset, access to the chosen portion of the asset is blocked (e.g., display of information with respect to the chosen portion is precluded). For example, read/writes to chosen database rows, running aspects of a chosen virtual machine, or the presentation of a media file may be suppressed. Accordingly, the first subset of the set of user-configurable access control toggles may be checked before carrying-out access requests such as the first access request.

In embodiments, the automated module 661 carries out one or more operational steps (e.g., the providing, the receiving of the prevention selection, the receiving of the first access request, the preventing) in an automated fashion without user intervention. The operational steps may each occur in an automated fashion without user intervention or manual action (e.g., using automated computing machinery, fully machine-driven without manual stimuli). The automated operational steps may be performed by a data access management engine (e.g., as part of a data management system), a cloud management engine (e.g., as part of a cloud environment), or the like.

In embodiments, the first allowance module 662 may allow a single asset to access different information from which it was prevented. An allowance selection with respect to a second subset of the set of user-configurable access control toggles may be received from the non-administrator user. The allowance selection can indicate to allow access to a second subset of the set of data for the first subset of the set of assets. Accordingly, the allowance selection can include an indicator, an indication, or the like which may be acquired via a selecting operation by the non-administrator user as described herein. For example, the allowance selection can include storing a data value which may be configured to permit access to a portion of data. A second access request to the second subset of the set of data may be received from the first subset of the set of assets. Based on the allowance selection with respect to the second subset of the set of user-configurable access control toggles, the second access request to the second subset of the set of data by the first subset of the set of assets may be performed. Performing can include processing, carrying-out, initiating, launching, instantiating, implementing, enacting, running, or executing one or more operations, jobs, or tasks. For instance, a single application program may have access to a second record of a certain database but not to a first record of the certain database. Similarly, the non-administrator user may prevent a single program from reading contents of a first logical partition of a single system while allowing writes to a second logical partition of the single system by the single program. As such, the non-administrator user may prevent a presentation of candidate birthday gifts (e.g., purchased on a specific website) on a compute module while allowing the presentation of household goods (e.g., purchased on the specific website) on the compute module.

In embodiments, the second allowance module 663 may allow a second asset to access the same information from which a first asset was prevented from accessing. An allowance selection with respect to a second subset of the set of user-configurable access control toggles may be received from the non-administrator user. The allowance selection can indicate to allow access to the first subset of the set of data for the second subset of the set of assets. A second access request to the first subset of the set of data may be received from the second subset of the set of assets. Based on the allowance selection with respect to the second subset of the set of user-configurable access control toggles, the second access request to the first subset of the set of data by the second subset of the set of assets can be performed. For instance, a first application program may not have access to a given record of a database but a second application program may have access to the given record of the database. Similarly, the non-administrator user may prevent a first program from reading contents of a particular logical partition of a single system while allowing a second program to write to the contents of the particular logical partition of the single system. As such, the non-administrator user may prevent a presentation of a birthday gift purchase history after authenticating that a first user (such as a child) is logged-in to a compute module while allowing the presentation of the birthday gift purchase history after authenticating that a second user (different from the first user such as a parent) is logged-in to the compute module.

In embodiments, the first denial module 664 may deny presentation of an advertisement with respect to a social networking environment. The social networking environment can include a selection from a group consisting of at least one of: e-mail, calendar, instant messaging (IM), short message services (SMS), wiki, community (e.g., micro-blog, professional connections, photo-sharing), newsfeed, project collaboration, product reviews, or the like. Denying can include preventing, rejecting, not allowing/receiving, disabling, disallowing, prohibiting, blocking, disregarding, suppressing, ignoring, precluding, or the like. Such denial may be included as at least a portion of preventing performance of the first access request to the first subset of the set of data by the first subset of the set of assets. The advertisement can include a customized message (e.g., individualized message) for the non-administrator user. For example, the denial may prevent an advertisement presentation (e.g., still image, video, audio) of similar items to previously purchased items (e.g., so that birthday gifts are not alluded to). To illustrate, perhaps two people are using a common computer to look into a trip to see family/friends on a travel website having various destination reviews. The first person may not want the second person to know that the first person has also been looking into a surprise ski getaway for two to a mountain resort. Aspects described herein may prove useful by allowing travel advertisements/deals to be presented with the exception of ski and mountain deals. As such, the two people may research their trip to see family/friends without the second person being alerted to the possible surprise ski getaway. Accordingly, certain portions of historical indicators (e.g., browsing activity related to destination reviews) may be toggled-off by the non-administrator user with respect to such customized messages. Other related possibilities are considered.

In embodiments, the second denial module 665 may deny the first subset of the set of assets from having access to a set of delicate information. The set of delicate information may include a set of personal identifiable information (e.g., biometric information, medical information, personally identifiable financial information, unique identifiers such as passport information, birthdays), a set of sensitive personal information (e.g., childcare information, names/addresses of family members, academic transcripts), a set of classified information (e.g., items meeting federal classification guidelines, items marked classified), a set of proprietary information (e.g., sales metrics, forecast pricing data, trade secrets), a set of export-controlled information (e.g., defense services information, weapons specifications, items marked as potentially export-controlled), or the like. Such denial may be included as at least a portion of preventing performance of the first access request to the first subset of the set of data by the first subset of the set of assets. Accordingly, the non-administrator user (e.g., in addition to or rather than an administrator user) can determine what types/categories of information various assets (such as application programs) may have access to. For example, the non-administrator user may have an e-mail account with a third-party that provides “free” e-mail. However, the third-party may allow the crawling of such free e-mail accounts as part of their terms of service. The crawling may be for the purpose of finding data that can be useful to advertisers or the like. Aspects described herein facilitate the non-administrator user to select subsets of e-mails to prevent the crawling thereof. As such, the third-party may require a threshold amount of e-mail to be crawled (e.g., at least 80% of the e-mails), but the non-administrator user may effectively hide the remainder from the crawling (e.g., up to the threshold amount which may contain delicate information) by using the user-configurable access control toggles. Accordingly, the third-party may indicate to the non-administrator user (e.g., via a graphical user interface prompt) when potentially delicate information is in their message (e.g., personally identifiable information appears) to provide performance or efficiency benefits to all parties including data security. Other related possibilities are considered.

In embodiments, the database records module 671 indicates that the set of data includes a set of records/entries of a database. The database may have one or more tables and one or more indexes. Various other data structures may be utilized. In various embodiments, the respective/individualized module 672 may be configured such that the set of user-configurable access control toggles manages access to the set of records on an individual record-by-record basis. As such, adjacent records may be treated differently with respect to reads and writes (e.g., not one-approach-fits-all for all records) based on have different values for their user-configurable access control toggles (e.g., a first record may be read by a program and the next subsequent second record may be disabled—by the non-administrator user—from being read by the program). In various embodiments, the respective/individualized module 672 may be configured such that the set of user-configurable access control toggles manages access to the set of records on an individual asset-by-asset basis. As such, different assets (e.g., programs, virtual machines) may be treated differently with respect to reads and writes (e.g., to a single record) based on have different values for their user-configurable access control toggles (e.g., a first application program may be able to write to the single record and a second application program may not be able to read/write to the single record). In various embodiments, the respective/individualized module 672 may be configured such that a respective user-configurable access control toggle indicates read-write access to a respective record (e.g., a toggle for each record, in certain embodiments a toggle for each program for each record). In various embodiments, the database may be structured (e.g., constructed, generated, created, established) to include a new column (e.g., not otherwise preexisting) in a set of table metadata (e.g., separated from content data of the table) that stores a set of Boolean values (e.g., 0, 1) for the set of user-configurable access control toggles. Accordingly, a respective Boolean value for the respective user-configurable access control toggle indicates whether to fulfill the first access request to the respective record (e.g., fulfill if 1 else ignore). Other related possibilities are considered.

In embodiments, the query directive module 673 includes a receiving operation, a determining operation, and an identifying operation. The receiving operation may receive a query directive (from the non-administrator user) which indicates the prevention selection. The query directive (e.g., a hint) may alter a query plan. The directive may indicate to force the optimizer to choose a particular type of query plan which adheres to the prevention selection (e.g., disabling performance of the first access request to the first subset of the set of data by the first subset of the set of assets). The determining operation may compute to prevent performance of the first access request to the first subset of the set of data based on the query directive (e.g., the hint indicates to disable performance for selected assets to selected records). Based on the determining, the prevention selection can be identified (e.g., performing a binary selection of which assets/records fit the criteria on an asset-by-asset/record-by-record basis). Accordingly, the database may ascertain at the time of query execution whether particular portions of data (e.g., particular records, particular fields) may be read (e.g., presented, displayed, played). Other related possibilities are considered.

In embodiments, the directive parameters module 674 includes extracting, from the query directive, a set of parameters which indicates when to identify the prevention selection (e.g., the criteria for which to prohibit access). Extracting can include extricating, deriving, pulling, filtering, selecting, or the like. The set of parameters may indicate one or more benchmarks, thresholds, or the like with respect to one or more parameter values. For instance, values within a threshold deviation of the benchmark may be allowed whereas values outside of the threshold deviation of the benchmark may be prevented from accessibility. In various embodiments, the directive parameters module 674 includes ascertaining that the set of parameters includes both a first temporal boundary value (e.g., 7:00 AM) and a second temporal boundary value (e.g., 11:00 PM), detecting a current temporal value (e.g., 1:00 PM), and identifying the prevention selection when the current temporal value exceeds the first temporal boundary value (e.g., 1:00 PM is after 7:00 AM), and the second temporal boundary value exceeds the current temporal value (e.g., 11:00 PM is after 1:00 PM). Accordingly, the prevention selection may disallow access during certain temporal periods (e.g., between 7:00 AM and 11:00 PM such as at 1:00 PM) while allow access at other times (e.g., for performance or efficiency benefits).

In embodiments, the dynamic module 675 may be configured such that a set of operational steps such as the providing, the receiving of the prevention selection, the receiving of the first access request, and the preventing each occur in a dynamic fashion to streamline data access management. As such, the set of operational steps may occur in real-time, ongoing, or on-the-fly. As an example, one or more operational steps described herein may be carried-out on an ongoing basis to facilitate, promote, or enhance data access management. Other related possibilities are considered.

The example system 600 may provide performance or efficiency benefits for data access management. For example, aspects of the example system 600 may have positive impacts with respect to flexibility in handling delicate information. Altogether, performance or efficiency benefits (e.g., speed, flexibility, information security, resource usage) may occur when the data access management described herein.

Consider a first example. A non-administrator user may visit a job search website and the job search website may provide one or more suggestions on profile matches (e.g., based on information input by the non-administrator user). Utilizing the same computer later in the day, the non-administrator user may be in a meeting for hiring in at their current company and is visiting the job search website for profiles to be recruited. Such a non-administrator user might be embarrassed by suggestion for themselves being provided. While the non-administrator user may not want to eliminate the data entirely, benefits may result from toggling at the level of the database so that such preferences may persist.

Consider a second example. A non-administrator user knows what to buy but is swamped with suggestions, which can lead to frustration. The non-administrator user may be allowed to toggle various analytical queries for a particular transaction. Accordingly, the non-administrator user may have non-static rules for toggling the analytical tasks (e.g., at a centralized management engine location). Certain transactions for analytical queries which are run by certain websites may be selected to not be recorded (e.g., and thereby not used in future analytical queries). As such, data at the database level can be marked to allow toggling with respect to taking part in analytical queries or the like.

In addition to embodiments described above, other embodiments having fewer operational steps, more operational steps, or different operational steps are contemplated. Also, some embodiments may perform some or all of the above operational steps in a different order. The modules are listed and described illustratively according to an embodiment and are not meant to indicate necessity of a particular module or exclusivity of other potential modules (or functions/purposes as applied to a specific module).

In the foregoing, reference is made to various embodiments. It should be understood, however, that this disclosure is not limited to the specifically described embodiments. Instead, any combination of the described features and elements, whether related to different embodiments or not, is contemplated to implement and practice this disclosure. Many modifications and variations may be apparent to those of ordinary skill in the art without departing from the scope and spirit of the described embodiments. Furthermore, although embodiments of this disclosure may achieve advantages over other possible solutions or over the prior art, whether or not a particular advantage is achieved by a given embodiment is not limiting of this disclosure. Thus, the described aspects, features, embodiments, and advantages are merely illustrative and are not considered elements or limitations of the appended claims except where explicitly recited in a claim(s).

The present invention may be a system, a method, and/or a computer program product. The computer program product may include a computer readable storage medium (or media) having computer readable program instructions thereon for causing a processor to carry out aspects of the present invention.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present invention may be assembler instructions, instruction-set-architecture (ISA) instructions, machine instructions, machine dependent instructions, microcode, firmware instructions, state-setting data, or either source code or object code written in any combination of one or more programming languages, including an object oriented programming language such as Java, Smalltalk, C++ or the like, and conventional procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present invention.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

Embodiments according to this disclosure may be provided to end-users through a cloud-computing infrastructure. Cloud computing generally refers to the provision of scalable computing resources as a service over a network. More formally, cloud computing may be defined as a computing capability that provides an abstraction between the computing resource and its underlying technical architecture (e.g., servers, storage, networks), enabling convenient, on-demand network access to a shared pool of configurable computing resources that can be rapidly provisioned and released with minimal management effort or service provider interaction. Thus, cloud computing allows a user to access virtual computing resources (e.g., storage, data, applications, and even complete virtualized computing systems) in “the cloud,” without regard for the underlying physical systems (or locations of those systems) used to provide the computing resources.

Typically, cloud-computing resources are provided to a user on a pay-per-use basis, where users are charged only for the computing resources actually used (e.g., an amount of storage space used by a user or a number of virtualized systems instantiated by the user). A user can access any of the resources that reside in the cloud at any time, and from anywhere across the Internet. In context of the present disclosure, a user may access applications or related data available in the cloud. For example, the nodes used to create a stream computing application may be virtual machines hosted by a cloud service provider. Doing so allows a user to access this information from any computing system attached to a network connected to the cloud (e.g., the Internet).

Embodiments of the present disclosure may also be delivered as part of a service engagement with a client corporation, nonprofit organization, government entity, internal organizational structure, or the like. These embodiments may include configuring a computer system to perform, and deploying software, hardware, and web services that implement, some or all of the methods described herein. These embodiments may also include analyzing the client's operations, creating recommendations responsive to the analysis, building systems that implement portions of the recommendations, integrating the systems into existing processes and infrastructure, metering use of the systems, allocating expenses to users of the systems, and billing for use of the systems.

The flowchart and block diagrams in the Figures illustrate the architecture, functionality, and operation of possible implementations of systems, methods, and computer program products according to various embodiments of the present invention. In this regard, each block in the flowchart or block diagrams may represent a module, segment, or portion of instructions, which comprises one or more executable instructions for implementing the specified logical function(s). In some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

While the foregoing is directed to exemplary embodiments, other and further embodiments of the invention may be devised without departing from the basic scope thereof, and the scope thereof is determined by the claims that follow. The descriptions of the various embodiments of the present disclosure have been presented for purposes of illustration, but are not intended to be exhaustive or limited to the embodiments disclosed. Many modifications and variations will be apparent to those of ordinary skill in the art without departing from the scope and spirit of the described embodiments. The terminology used herein is for the purpose of describing particular embodiments only and is not intended to be limiting of the various embodiments. As used herein, the singular forms “a,” “an,” and “the” are intended to include the plural forms as well, unless the context clearly indicates otherwise. “Set of,” “group of,” “bunch of,” etc. are intended to include one or more. It will be further understood that the terms “includes” and/or “including,” when used in this specification, specify the presence of the stated features, integers, steps, operations, elements, and/or components, but do not preclude the presence or addition of one or more other features, integers, steps, operations, elements, components, and/or groups thereof. The terminology used herein was chosen to explain the principles of the embodiments, the practical application or technical improvement over technologies found in the marketplace, or to enable others of ordinary skill in the art to understand the embodiments disclosed herein.

The terminology used herein is for the purpose of describing particular embodiments only and is not intended to be limiting of the various embodiments. As used herein, the singular forms “a,” “an,” and “the” are intended to include the plural forms as well, unless the context clearly indicates otherwise. “Set of,” “group of,” “bunch of,” etc. are intended to include one or more. It will be further understood that the terms “includes” and/or “including,” when used in this specification, specify the presence of the stated features, integers, steps, operations, elements, and/or components, but do not preclude the presence or addition of one or more other features, integers, steps, operations, elements, components, and/or groups thereof. In the previous detailed description of exemplary embodiments of the various embodiments, reference was made to the accompanying drawings (where like numbers represent like elements), which form a part hereof, and in which is shown by way of illustration specific exemplary embodiments in which the various embodiments may be practiced. These embodiments were described in sufficient detail to enable those skilled in the art to practice the embodiments, but other embodiments may be used and logical, mechanical, electrical, and other changes may be made without departing from the scope of the various embodiments. In the previous description, numerous specific details were set forth to provide a thorough understanding the various embodiments. But, the various embodiments may be practiced without these specific details. In other instances, well-known circuits, structures, and techniques have not been shown in detail in order not to obscure embodiments.

What is claimed is:

1. A computer-implemented method for data access management, the method comprising:
providing, to a non-administrator user, a set of user-configurable access control toggles which indicates access authorization to a set of data for a set of assets;
receiving, from the non-administrator user, a prevention selection with respect to a first subset of the set of user-configurable access control toggles which indicates to prevent access to a first subset of the set of data for a first subset of the set of assets;
receiving, from the first subset of the set of assets, a first access request to the first subset of the set of data; and
preventing, based on the prevention selection with respect to the first subset of the set of user-configurable access control toggles, performance of the first access request to the first subset of the set of data by the first subset of the set of assets.

2. The method of claim 1, further comprising:
receiving, from the non-administrator user, an allowance selection with respect to a second subset of the set of user-configurable access control toggles which indicates to allow access to a second subset of the set of data for the first subset of the set of assets;
receiving, from the first subset of the set of assets, a second access request to the second subset of the set of data; and
performing, based on the allowance selection with respect to the second subset of the set of user-configurable access control toggles, the second access request to the second subset of the set of data by the first subset of the set of assets.

3. The method of claim 1, further comprising:
receiving, from the non-administrator user, an allowance selection with respect to a second subset of the set of user-configurable access control toggles which indicates to allow access to the first subset of the set of data for the second subset of the set of assets;
receiving, from the second subset of the set of assets, a second access request to the first subset of the set of data; and
performing, based on the allowance selection with respect to the second subset of the set of user-configurable access control toggles, the second access request to the first subset of the set of data by the second subset of the set of assets.

4. The method of claim 1, wherein the set of data includes a set of records of a database.

5. The method of claim 4, wherein the set of user-configurable access control toggles manages access to the set of records on an individual record-by-record basis.

6. The method of claim 4, wherein the set of user-configurable access control toggles manages access to the set of records on an individual asset-by-asset basis.

7. The method of claim 4, wherein a respective user-configurable access control toggle indicates read-write access to a respective record.

8. The method of claim 7, further comprising:
structuring the database to include a new column in a set of table metadata that stores a set of Boolean values for the set of user-configurable access control toggles, wherein a respective Boolean value for the respective user-configurable access control toggle indicates whether to fulfill the first access request to the respective record.

9. The method of claim 1, wherein the set of assets includes a set of application programs.

10. The method of claim 1, further comprising:
selecting, by an administrator-user in advance of providing the set of user-configurable access control toggles to the non-administrator user, enablement of the set of user-configurable access control toggles.

11. The method of claim 1, further comprising:
receiving, from the non-administrator user, a query directive which indicates the prevention selection;
determining, based on the query directive, to prevent performance of the first access request to the first subset of the set of data; and
identifying, based on the determining, the prevention selection.

12. The method of claim 11, further comprising:
extracting, from the query directive, a set of parameters which indicates when to identify the prevention selection.

13. The method of claim 12, further comprising:
ascertaining that the set of parameters includes both a first temporal boundary value and a second temporal boundary value;
detecting a current temporal value; and
identifying the prevention selection when:
the current temporal value exceeds the first temporal boundary value, and
the second temporal boundary value exceeds the current temporal value.

14. The method of claim 1, wherein preventing performance of the first access request to the first subset of the set of data by the first subset of the set of assets includes:
denying presentation of an advertisement with respect to a social networking environment, wherein the advertisement includes a customized message for the non-administrator user.

15. The method of claim 1, wherein preventing performance of the first access request to the first subset of the set of data by the first subset of the set of assets includes:
denying the first subset of the set of assets from having access to a set of delicate information.

16. The method of claim 1, wherein the providing, the receiving of the prevention selection, the receiving of the first access request, and the preventing each occur in a dynamic fashion to streamline data access management.

17. The method of claim 1, wherein the providing, the receiving of the prevention selection, the receiving of the first access request, and the preventing each occur in an automated fashion without user intervention.

18. A system for data access management, the system comprising:
a memory having a set of computer readable computer instructions, and
a processor for executing the set of computer readable instructions, the set of computer readable instructions including:
providing, to a non-administrator user, a set of user-configurable access control toggles which indicates access authorization to a set of data for a set of assets;
receiving, from the non-administrator user, a prevention selection with respect to a first subset of the set of user-configurable access control toggles which indicates to prevent access to a first subset of the set of data for a first subset of the set of assets;
receiving, from the first subset of the set of assets, a first access request to the first subset of the set of data; and
preventing, based on the prevention selection with respect to the first subset of the set of user-configurable access control toggles, performance of the first access request to the first subset of the set of data by the first subset of the set of assets.

19. A computer program product for data access management, the computer program product comprising a computer readable storage medium having program instructions embodied therewith, wherein the computer readable storage medium is not a transitory signal per se, the program instructions executable by a processor to cause the processor to perform a method comprising:
providing, to a non-administrator user, a set of user-configurable access control toggles which indicates access authorization to a set of data for a set of assets;
receiving, from the non-administrator user, a prevention selection with respect to a first subset of the set of user-configurable access control toggles which indicates to prevent access to a first subset of the set of data for a first subset of the set of assets;
receiving, from the first subset of the set of assets, a first access request to the first subset of the set of data; and
preventing, based on the prevention selection with respect to the first subset of the set of user-configurable access control toggles, performance of the first access request to the first subset of the set of data by the first subset of the set of assets.

20. The computer program product of claim 19, wherein at least one of:
the program instructions are stored in the computer readable storage medium in a data processing system, and wherein the program instructions were downloaded over a network from a remote data processing system; or
the program instructions are stored in the computer readable storage medium in a server data processing system, and wherein the program instructions are downloaded over a network to the remote data processing system for use in a second computer readable storage medium with the remote data processing system.
